(19) United States
(12) Patent Application Publication
(10) Pub. No.: US 2026/0285275 A1
(43) Pub. Date: Sep. 24, 2026

(54) BRAKE APPARATUS FOR VEHICLES

(71) Applicant: HYUNDAI MOBIS CO., LTD., Seoul (KR)

(72) Inventors: Chang Hoe KOO, Yongin-si (KR); Byung Jun KIM, Yongin-si (KR)

(73) Assignee: HYUNDAI MOBIS CO., LTD., Seoul (KR)

(21) Appl. No.: 19/414,214

(22) Filed: Dec. 9, 2025

(30) Foreign Application Priority Data
Mar. 21, 2025 (KR) 10-2025-0036770

(51) Int. Cl. B60T 13/14; B60T 13/58; B60T 13/66; B60T 13/74

(52) U.S. Cl. CPC B60T 13/142; B60T 13/588; B60T 13/662; B60T 13/745; B60T 2270/402

(57) ABSTRACT

A brake apparatus includes a reservoir configured to store brake fluid, a backup master cylinder unit connected to the reservoir and configured to generate hydraulic pressure of a brake fluid by pressing of a pedal, a main master cylinder unit connected to the backup master cylinder unit and configured to generate hydraulic pressure of the brake fluid by driving a motor, and a block unit on which the backup master cylinder unit is mounted, the block unit including a flow path through which the brake fluid flows, and an inner circumferential surface into which an outer circumferential surface of a main cylinder of the main master cylinder unit is press-fitted.

### CROSS-REFERENCE TO RELATED APPLICATION

The present application claims priority and the benefit of Korean Patent Application No. 10-2025-0036770, filed on March 21, 2025 in the Korean Intellectual Property Office, the entire disclosure of which is incorporated herein by reference.

### BACKGROUND

### Field

Exemplary embodiments of the present disclosure relate to a brake apparatus for vehicles.

### Description of the Related Art

In general, due to the characteristics of electrically-powered brake apparatuses for vehicles, a mechanism configured to convert a rotational motion of a motor into a linear motion of a piston in a cylinder to generate hydraulic brake pressure is required.

A ball screw device is applied to an electric brake apparatus as the mechanism for converting the rotational motion of the motor into the linear motion. The ball screw device includes a screw shaft that receives rotational force from the motor and rotates on an axis, a nut coupled to the screw shaft via balls and configured to move in an axial direction of the screw shaft, and a piston coupled to the nut and configured to pressurize a brake fluid in the cylinder.

In a conventional brake apparatus, a motor guide was used when installing a motor unit in a main master cylinder unit, however, in this case, it was difficult to manage the squareness and tolerance between the motor guide and the cylinder body, requiring post-processing and resulting in disadvantages in terms of quality control and cost.

The background art of the present disclosure is disclosed in Korean Patent Laid-open Publication No. 10-2021-0064367 (published on Jun. 2, 2021, entitled “Hydraulic Unit for Hydraulic Vehicle Brake System”).

### SUMMARY

Various embodiments are directed to providing a brake apparatus for vehicles that secures concentricity between a main master cylinder unit and a motor.

A brake apparatus for vehicles according to an embodiment of the present disclosure may include: a reservoir configured to store brake fluid; a backup master cylinder unit connected to the reservoir and configured to generate hydraulic pressure of a brake fluid by pressing of a pedal; a main master cylinder unit connected to the backup master cylinder unit and configured to generate hydraulic pressure of the brake fluid by driving a motor; and a block unit on which the backup master cylinder unit is mounted, the block unit including a flow path through which the brake fluid flows, and an inner circumferential surface into which an outer circumferential surface of a main cylinder of the main master cylinder unit is press-fitted.

The block unit may include a main mounting bore passing through a first surface and a second surface of the block unit. The main mounting bore may include a first block press-fitting portion disposed adjacent to the first surface. An outer circumferential surface of the main cylinder may be press-fitted into the first block press-fitting portion.

The main cylinder may include a first cylinder press-fitting portion including a first stepped portion press-fitted into the first block press-fitting portion.

The first stepped portion may include: a first press-fitting portion press-fitted into the first block press-fitting portion; and a first positioning shoulder portion having an outer diameter larger than an outer diameter of the first press-fitting portion so as to be stepped with respect to the first press-fitting portion, the first positioning shoulder portion determining a position of the main cylinder inside the block unit.

The block unit may include a main mounting bore passing through a first surface and a second surface of the block unit, the main mounting bore including a second block press-fitting portion disposed adjacent to the second surface. An outer circumferential surface of the main cylinder may be press-fitted into the second block press-fitting portion.

The main cylinder may include a second cylinder press-fitting portion including a second stepped portion press-fitted into the second block press-fitting portion.

The second stepped portion may include: a second press-fitting portion press-fitted into the second block press-fitting portion; and a second positioning shoulder portion having an outer diameter larger than an outer diameter of the second press-fitting portion so as to be stepped with respect to the second press-fitting portion, the second positioning shoulder portion determining a position of the main cylinder inside the block unit.

The motor may be mounted on the first surface, and an angle formed between a central axis of the main mounting bore and the first surface may be a right angle.

A plurality of positioning protrusions may be provided on the first surface. The motor may be fitted to the plurality of positioning protrusions and mounted to the first surface.

### BRIEF DESCRIPTION OF THE DRAWINGS

FIG. 1 is a hydraulic circuit diagram illustrating a brake apparatus for vehicles according to an embodiment of the present disclosure.

FIG. 2 is a block diagram schematically illustrating the brake apparatus for vehicles according to an embodiment of the present disclosure.

FIG. 3 is an exploded perspective view illustrating the brake apparatus for vehicles according to an embodiment of the present disclosure.

FIG. 4 is a sectional view illustrating a main master cylinder unit separated from a block unit according to an embodiment of the present disclosure.

FIG. 5 is an enlarged view of portion A of FIG. 4.

FIG. 6 is a sectional view illustrating the main master cylinder coupled to the block unit, according to an embodiment of the present disclosure.

FIG. 7 is an enlarged view of portion B of FIG. 6.

FIG. 8 is a sectional view illustrating the main master cylinder unit and a motor that are coupled to the block unit, according to an embodiment of the present disclosure.

### DETAILED DESCRIPTION

Hereinafter, embodiments of a brake apparatus for vehicles according to the present disclosure will be described with reference to the accompanying drawings. It should be noted that the drawings are not to precise scale and may be exaggerated in thickness of lines or sizes of components for descriptive convenience and clarity only. Furthermore, the terms as used herein are defined by taking functions of the present disclosure into account and can be changed according to the custom or intention of users or operators. Therefore, definition of the terms should be made according to the overall disclosures set forth herein.

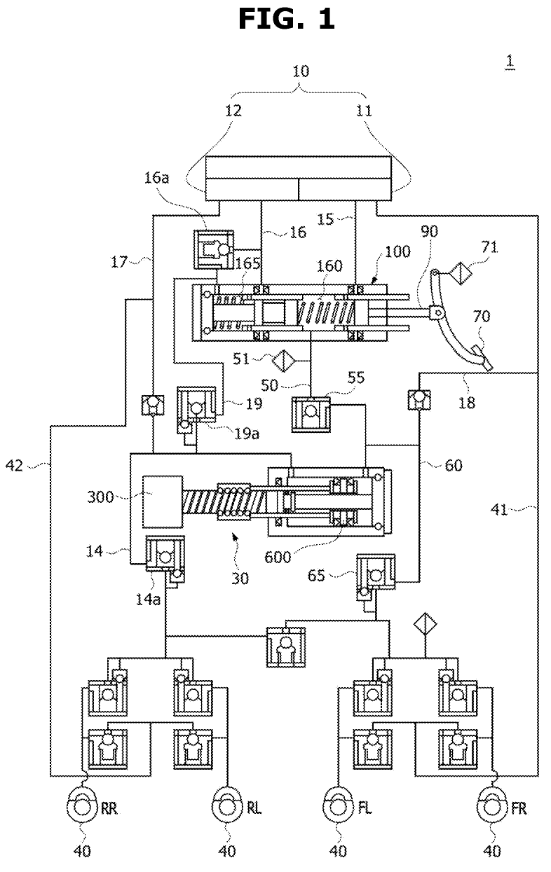

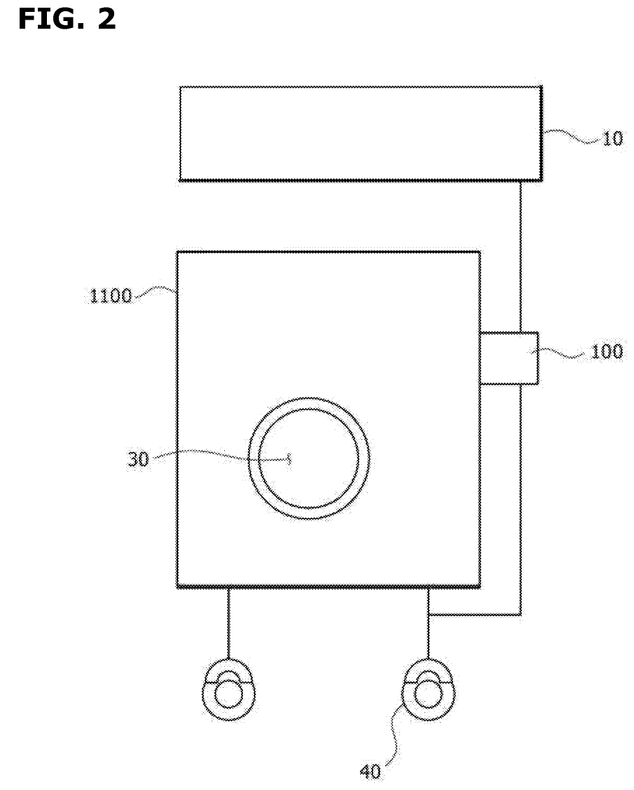

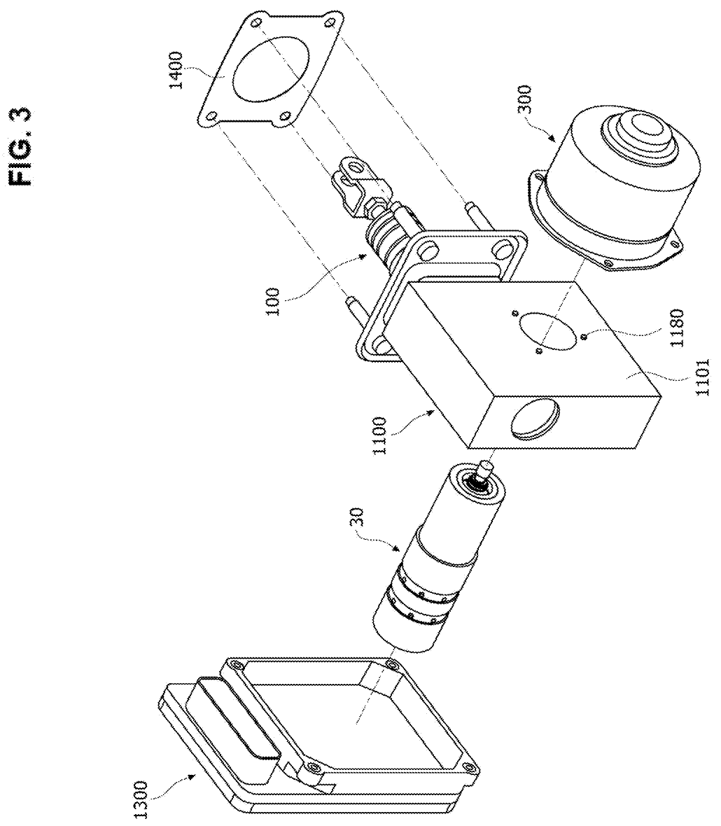

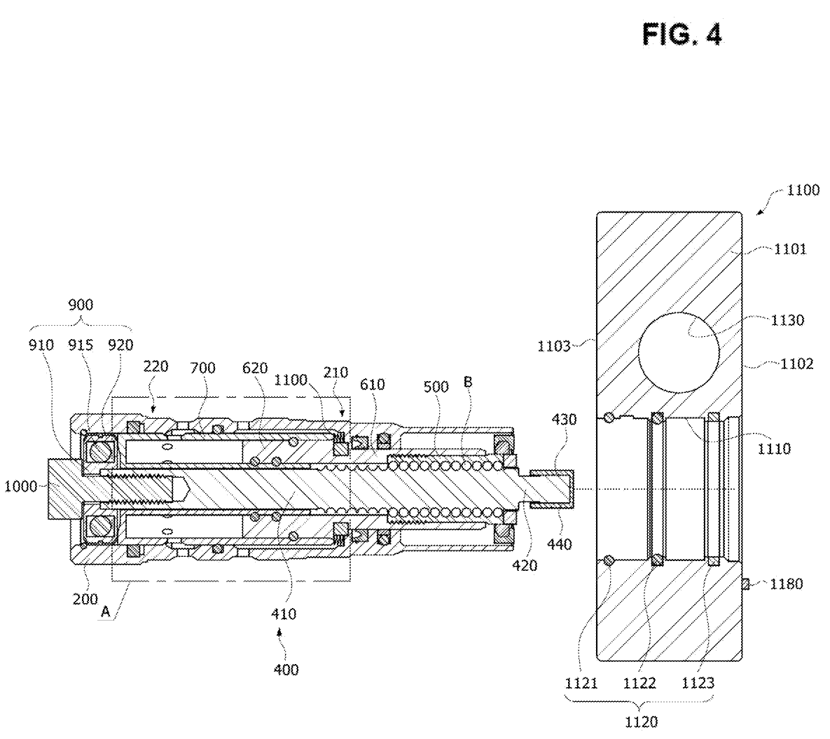

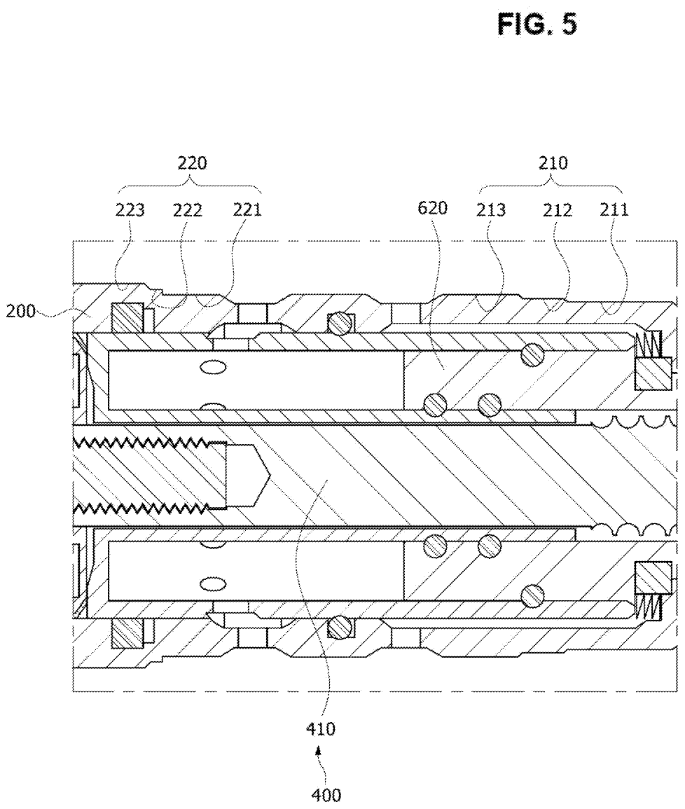

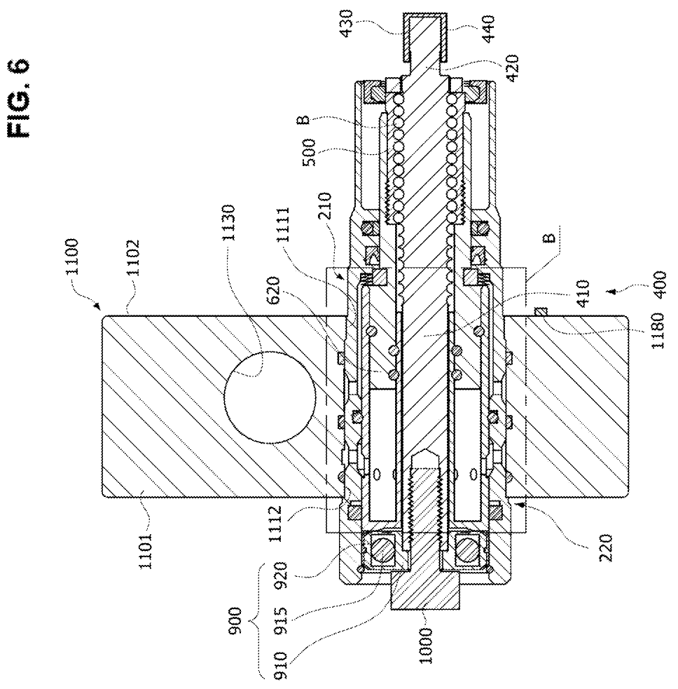

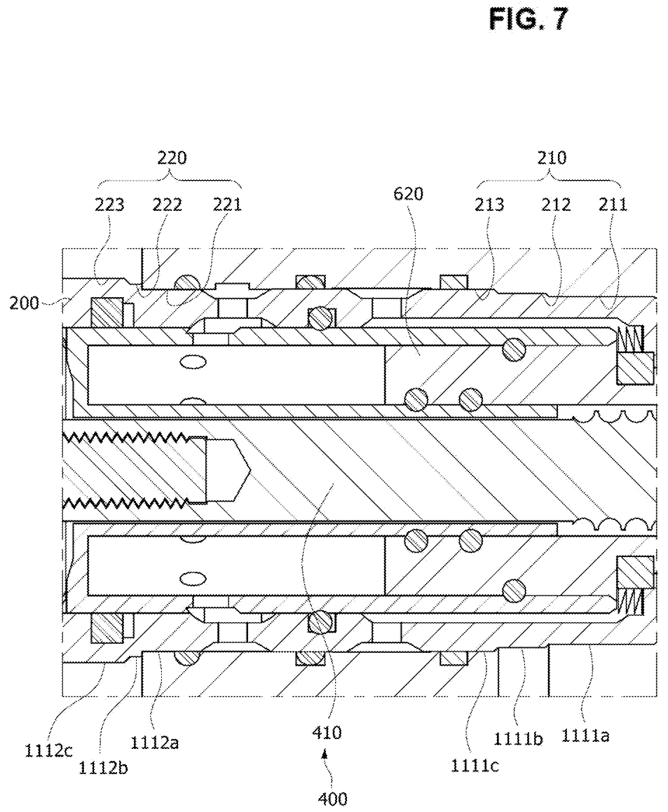

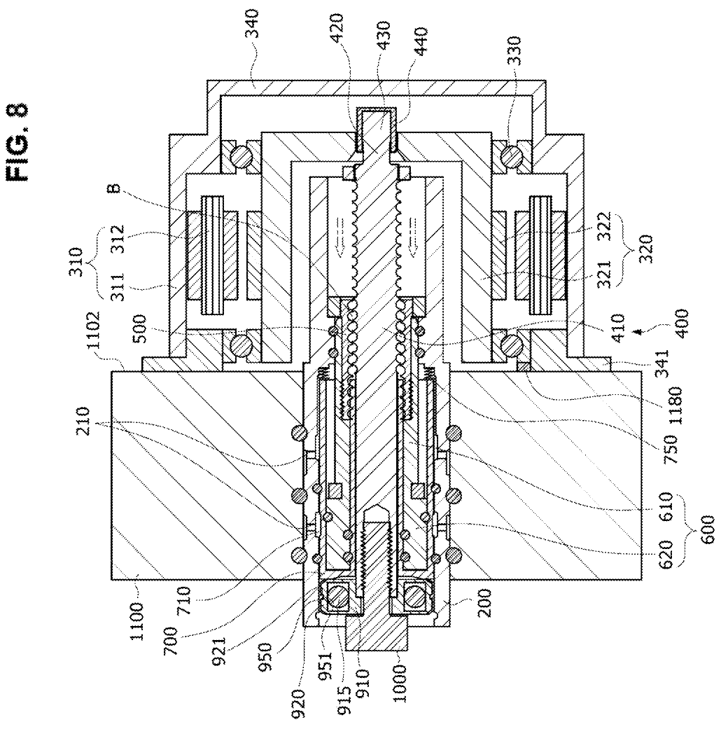

FIG. 1 is a hydraulic circuit diagram illustrating a brake apparatus for vehicles according to an embodiment of the present disclosure. FIG. 2 is a block diagram schematically illustrating the brake apparatus for vehicles according to an embodiment of the present disclosure. FIG. 3 is an exploded perspective view illustrating the brake apparatus for vehicles according to an embodiment of the present disclosure. FIG. 4 is a sectional view illustrating a main master cylinder unit separated from a block unit according to an embodiment of the present disclosure. FIG. 5 is an enlarged view of portion A of FIG. 4. FIG. 6 is a sectional view illustrating the main master cylinder coupled to the block unit, according to an embodiment of the present disclosure. FIG. 7 is an enlarged view of portion B of FIG. 6. FIG. 8 is a sectional view illustrating the main master cylinder unit and a motor that are coupled to the block unit, according to an embodiment of the present disclosure.

Referring to FIGS. 1 to 8, a brake apparatus 1 for vehicles according to an embodiment of the present disclosure may include a reservoir 10, a main master cylinder unit 30, a backup master cylinder unit 100, a motor 300, a block unit 1100, and an electronic control unit (ECU) 1300.

The reservoir 10 may store brake fluid. The reservoir 10 may be sectioned into a first storage portion 11 and a second storage portion 12. The reservoir 10 may be connected to the backup master cylinder unit 100 to supply brake fluid to the backup master cylinder unit 100.

The brake fluid discharged from the reservoir 10 may flow toward and be supplied to a plurality of wheel cylinders 40, thereby satisfying required braking force. The reservoir 10 may be connected to the wheel cylinders 40 to recover the brake fluid.

The backup master cylinder unit 100 is located between the reservoir 10 and the wheel cylinders 40. The backup master cylinder unit 100 is connected to the reservoir 10 and may generate hydraulic pressure by pressing of a pedal 70. The brake apparatus 1 for vehicles may include the pedal 70, a pedal stroke sensor 71, an operating rod 90, and a backup cylinder.

The pedal 70 is a component that is pressed by a driver to perform braking. The pedal stroke sensor 71 provided on the pedal 70 may sense a stroke of the pedal 70. The operating rod 90 may interlock with depression of the pedal 70 and pressurize an interior of the backup cylinder.

The backup cylinder may include a first backup chamber 160 and a second backup chamber 165 each of which stores the brake fluid. The first backup chamber 160 and the second backup chamber 165 are not in communication with each other.

Through an open end of the first backup chamber 160 (a right end based on FIG. 1), the operating rod 90 and a backup piston connected to the operating rod 90 may be inserted into the backup cylinder.

When a user, that is, a driver, depresses the pedal 70, in other words, steps on the pedal 70, the operating rod 90 and the backup piston may move forward (to the left based on FIG. 1) in the first backup chamber 160, thus pressurizing the brake fluid.

As the first backup chamber 160 is pressurized, the brake fluid in the second backup chamber 165 may also be pressurized. A stopper may be disposed at an end of the second backup chamber 165, and movement of a pedal simulator piston installed inside the second backup chamber 165 may be restricted by the stopper, thus providing pedal feel to the driver.

A first backup flow path 15 is connected at an end thereof to the first storage portion 11 and at a remaining end thereof to the first backup chamber 160. The brake fluid discharged from the first storage portion 11 may be supplied to the first backup chamber 160 through the first backup flow path 15.

A second backup flow path 16 is connected at an end thereof to the second storage portion 12 and at a remaining end thereof to the second backup chamber 165. The brake fluid discharged from the second storage portion 12 may be supplied to the second backup chamber 165 through the second backup flow path 16.

A first backup valve 16a may be disposed on the second backup flow path 16. The first backup valve 16a may be of a normally closed type and may remain in a closed state in a non-powered mode. More specifically, the first backup valve 16a may block the brake fluid from flowing from the second backup chamber 165 to the second storage portion 12.

The main master cylinder unit 30 may generate hydraulic pressure by driving the motor 300. In an embodiment, the main master cylinder unit 30 adjusts hydraulic pressure of the brake fluid by a piston 600 that is moved by driving the motor 300, thus generating required braking force. A plurality of main chambers in which the brake fluid is stored may be provided inside the main master cylinder unit 30.

The main master cylinder unit 30 may be connected to the plurality of wheel cylinders 40 and may supply the brake fluid to the wheel cylinders 40. The wheel cylinders 40 to which the brake fluid is supplied may provide braking force to vehicle wheels.

In the case where the main master cylinder unit 30 normally operates, the brake fluid pressurized by the motor 300 may be supplied to the wheel cylinders 40. In the case where the main master cylinder unit 30 malfunctions, the brake fluid pressurized by pressing of the pedal 70 may be supplied to the wheel cylinders 40.

A third backup flow path 17 is connected at an end thereof to the second storage portion 12 and at a remaining end thereof to a main flow path 14. The flow of the brake fluid discharged from the second storage portion 12 may be controlled by a control valve 14a.

At least one check valve may be disposed on the third backup flow path 17. The check valve may block the brake fluid from flowing backward from the main chambers of the main master cylinder unit 30 to the second storage portion 12.

A fourth backup flow path 18 may be connected at an end thereof to a first recovery flow path 41 and at a remaining end thereof to the main chambers of the main master cylinder unit 30. The first recovery flow path 41 is connected to the first storage portion 11. Accordingly, the brake fluid discharged from the wheel cylinders 40 may be recovered to the reservoir 10.

At least one check valve may be disposed on the fourth backup flow path 18. The check valve may block the brake fluid from flowing backward from the main chambers of the main master cylinder unit 30 to the first recovery flow path 41.

A second recovery flow path 42 is connected to the second storage portion 12. Therefore, the brake fluid discharged from the wheel cylinders 40 may be recovered to the reservoir 10.

A fifth backup flow path 19 may be connected at an end thereof to the second backup flow path 16 and at a remaining end thereof to the main flow path 14. A second backup valve 19a may be disposed on the fifth backup flow path 19. The second backup valve 19a may be of a normally open type.

The main flow path 14 may be connected to the main master cylinder unit 30. The brake fluid discharged from the main master cylinder unit 30 may flow through the main flow path 14. The wheel cylinders 40 may receive the brake fluid from the main master cylinder unit 30 through the main flow path 14.

The control valve 14a configured to open and close the main flow path 14 may be disposed at a point on the main flow path 14. The control valve 14a may be of a normally open type. Accordingly, the control valve 14a may be open in the non-powered mode.

A first flow path 50 connects the backup master cylinder unit 100 and the main master cylinder unit 30. The brake fluid may flow through the first flow path 50. The first flow path 50 is connected at an end thereof to the first backup chamber 160 and at a remaining end thereof to a first main chamber of the main master cylinder unit 30.

A hydraulic pressure sensor 51 may be provided on the first flow path 50. The hydraulic pressure sensor 51 may be disposed on the first flow path 50 between the first backup chamber 160 and a first valve 55. The hydraulic pressure sensor 51 may sense hydraulic pressure of the brake fluid generated by the backup master cylinder unit 100.

The first valve 55 may be located on the first flow path 50 and may control the flow of the brake fluid. The first valve 55 may be of a normally open type.

A second flow path 60 may be connected to the main master cylinder unit 30. The brake fluid discharged from the main master cylinder unit 30 may flow through the second flow path 60. The second flow path 60 is connected to the first main chamber of the main master cylinder unit 30. Accordingly, the wheel cylinders 40 may receive the brake fluid from the main master cylinder unit 30 through the second flow path 60.

A second valve 65 may be located on the second flow path 60 and may control the flow of brake fluid. The second valve 65 is disposed at a point on the second flow path 60 to open and close the second flow path 60. The second valve 65 may be of a normally open type. Accordingly, the second valve 65 is open in a non-powered mode. In the case where the second valve 65 is closed, the flow of the brake fluid through the second flow path 60 may be blocked.

A controller may be configured to control operations of the first valve 55, the second valve 65, the first backup valve 16a, the second backup valve 16a, the control valve 14a, and the like. The controller may execute a control algorithm stored in its memory to operate the valves described herein. The controller may be implemented using general-purpose hardware, firmware, or software, and a person skilled in the art can readily implement such a controller using known ECU techniques. In the drawings, the controller is not illustrated in detail because it may be implemented using any conventional electronic control unit (ECU), microprocessor, or control circuit, and the internal structure of the controller is not essential for understanding the present invention. When the driver depresses the pedal 70, the controller may provide pedal feel corresponding to the depression of the pedal 70 by controlling the first valve 55 and the first backup valve 16a. Accordingly, the pedal reaction force may be simulated according to the present disclosure.

In the case where the brake apparatus for vehicles operates normally, when the pedal 70 is pressed during vehicle travel, the main master cylinder unit 30 may be driven in response to a pedal pressing degree sensed by the backup master cylinder unit 100. The brake fluid pressurized by the main master cylinder unit 30 is supplied to the wheel cylinders 40, thus implementing braking of the vehicle.

The first valve 55 may be a normally open valve. In the case where the brake apparatus operates normally, power may be supplied to the first valve 55 to block the brake fluid from flowing from the first flow path 50 to the second flow path 60.

In the case where the brake apparatus operates abnormally, no power is supplied to the first valve 55, causing the flow path to open, thereby connecting the first flow path 50 and the second flow path 60. In this state, if the pedal 70 is pressed while the vehicle travels, the brake fluid pressurized by the backup master cylinder unit 100 passes through the first flow path 50 and the second flow path 60, and is then supplied to the wheel cylinders 40, thus implementing braking of the vehicle.

The main master cylinder unit 30 according to an embodiment may include a main cylinder 200, a screw shaft 400, a nut 500, a piston 600, a sleeve 700, and a bearing 900.

The main cylinder 200 may be disposed inside the block unit 1100 and may withstand torque generated by formation of hydraulic pressure according to reciprocating movement of the piston 600. The block unit 1100 may have a hollow shape in which an internal space is provided, and an outer circumferential surface of the main cylinder 200 may be press-fitted to an inner circumferential surface of the block unit 1100.

The main cylinder 200 may be assembled to the block unit 1100 with controlled concentricity. The block unit 1100 may be provided on an outer side of the main cylinder 200.

The main cylinder 200 may have a hollow shape. The sleeve 700 having an operation section formed therein to allow hydraulic pressure to be formed by pressing of the piston 600 may be disposed in a space at one side (at the left side based on FIG. 4) inside the main cylinder 200.

The motor 300 may be connected to the main cylinder 200, and various types of drive devices may be used within a technical idea in which rotational power can be generated. The motor 300 may transmit rotational power (torque) to the screw shaft 400.

The motor 300 may include a stationary component 310, a rotational component 320, and a motor bearing 330.

The stationary component 310 may include a fixing frame 311, and a stator 312 that is installed on an inner surface of the fixing frame 311 facing the rotational component 320 and is configured to generate magnetic force. The rotational component 320 may be rotatably installed inside the fixing frame 311.

The stator 312, which is an electromagnet, may be installed in a circumferential direction on the inner surface of the fixing frame 311, and may rotate the rotational component 320 by varying magnetic flux in response to a control signal from the controller (not shown).

The rotational component 320 may be connected to the screw shaft 400 and may rotate together with the screw shaft 400. The rotational component 320 may be modified into various shapes within a technical idea in which the rotational component 320 can rotate according to variation in magnetic force of the stator 312.

The rotational component 320 may be rotatably installed inside the fixing frame 311. The rotational component 320 may have an approximately "C"-shaped cross-section and may be formed in a hollow shape.

The rotational component 320 may include a rotational frame 321 installed in a shape enclosing one side of the main cylinder 200, and a rotor 322 that is provided on an outer surface of the rotational frame 321 facing the stationary component 310 and has magnetic force.

A spline that engages with the screw shaft 400 may be formed in the rotational frame 321, specifically on an inner surface of the rotational frame 321.

The motor bearing 330 may be provided between the stationary component 310 and the rotational component 320 to reduce friction generated during rotation of the rotational component 320. The rotor 322, which is formed of a plurality of magnets installed in a circumferential direction of the rotational frame 321, may rotate along with the rotational frame 321 by variation in magnetic force of the stator 312.

A cover assembly 340 and 341 may be installed in a shape enclosing an outer surface of an end of the rotational frame 321 to prevent introduction of foreign substances. The cover assembly 340 and 341 may include a motor housing 340 and a motor cover 341 detachably coupled to the motor housing 340.

In an embodiment of the present disclosure, the motor housing 340 may be integrally formed with the fixing frame 311. Alternatively, the motor housing 340 may serve as the fixing frame 311, and the stator 312 may be installed on an inner surface of the motor housing 340.

The motor cover 341 of the cover assembly 340 and 341 may be coupled in contact with the block unit 1100. An inner portion of the motor cover 341 may be fitted onto a positioning protrusion 1180 formed on a first surface 1102 of a block unit 1100 so that the motor cover 341 can be positioned at a correct position on the block unit 1100.

The screw shaft 400 may be provided inside the main cylinder 200. The screw shaft 400 may be inserted in a longitudinal direction of the main cylinder 200 and may be axially coupled to the main cylinder 200. A central axis of the main cylinder 200 and a central axis of the screw shaft 400 may be coaxial with each other.

The screw shaft 400 may include a screw body 410, a neck portion 420, and a power transmission portion 430.

The screw body 410 may be rotatably installed inside the main cylinder 200 and may include a helical thread formed along a longitudinal direction of the screw shaft 400. The screw body 410 may be located inside the rotational frame 321 of the motor 300.

The neck portion 420 may protrude toward a first side from an outer surface of the screw body 410 at a rotational center, and may be formed to have a diameter smaller than that of the screw body 410.

The power transmission portion 430 may extend toward the first side from a free end of the neck portion 420, and may be formed to have a diameter larger than that of the neck portion 420.

A spline may be formed along a circumferential direction on an outer surface of the power transmission portion 430 facing the rotational frame 321. Accordingly, in the case where a shaft cover 440 is not provided, the rotational frame 321 and the power transmission portion 430 may engage with each other to transmit power.

The screw shaft 400 may further include the shaft cover 440. The shaft cover 440 may be disposed to enclose the neck portion 420 and the power transmission portion 430. The shaft cover 440 may be interposed between the power transmission portion 430 and the rotational frame 321 to prevent metallic rattle noise from being generated.

A spline may be formed on an outer surface of the shaft cover 440 along a circumferential direction of the shaft cover 440 and may engage with the rotational frame 321. An outer shape of the shaft cover 440 may correspond to an outer shape of the power transmission portion 430.

A spline may be formed along a circumferential direction on an outer surface of the power transmission portion 430 facing the shaft cover 440. Accordingly, the shaft cover 440 and the power transmission portion 430 may engage with each other to transmit power.

The nut 500 may be positioned inside the rotational frame 321 of the motor 300 and may be located inside the main cylinder 200.

The nut 500 may be coupled to an outer surface of the screw shaft 400 via a ball B.

The screw shaft 400 may be coupled through the nut 500. Because the ball B is located between a helical thread formed on an inner surface of the nut 500 and the helical thread formed on an outer surface of the screw body 410, rotational motion of the screw shaft 400 may be converted into linear motion through the nut 500.

A rotation prevention protrusion (not shown) may be formed on an outer surface of the nut 500, and a movement groove (not shown) may be formed in an inner surface of the main cylinder 200.

When the screw shaft 400 rotates, the nut 500 does not rotate because rotation of the rotation prevention protrusion of the nut 500 is blocked by the movement groove. Accordingly, the rotational motion of the screw shaft 400 may be converted into the linear motion of the nut 500 by the rotation prevention protrusion and the movement groove.

The nut 500 may reciprocate in an axial direction of the screw shaft 400 according to a rotational direction of the screw shaft 400. For example, if the nut 500 moves forward when the screw shaft 400 rotates in a first direction, the nut 500 may move backward when the screw shaft 400 rotates in a second direction opposite to the first direction.

The piston 600 may be coupled in a shape of enclosing an outer side of the nut 500. The piston 600 may move in the longitudinal direction of the main cylinder 200 in conjunction with the reciprocating movement of the nut 500.

The piston 600 may include a rod 610 and a head 620.

The rod 610 may be formed in a hollow shape and may be positioned inside the rotational frame 321 of the motor 300. The outer surface of the nut 500 and an inner surface of the rod 610 may be threadedly coupled to each other.

The head 620 may be integrally formed with the rod 610. An outer diameter of the head 620 may be greater than an outer diameter of the rod 610.

The head 620 may be formed in a ring shape, may be positioned inside the block unit 1100, and may reciprocate inside the sleeve 700 to move the brake fluid inside the sleeve 700 toward ports 210. Accordingly, the main cylinder 200 may form a double-acting hydraulic pressure according to reciprocating movement of the piston 600.

The sleeve 700 may be positioned inside the block unit 1100 and may be disposed inside the main cylinder 200. The sleeve 700 may guide movement of the piston 600 inserted therein.

The sleeve 700 may be formed to enclose the head 620 of the piston 600.

The ports 210 through which the brake fluid flows may be formed on an outer surface of a region of the main cylinder 200 where the sleeve 700 is located. The ports 210 may be respectively provided at a plurality of points along the longitudinal direction of the cylinder 200. The brake fluid that flows according to movement of the piston 600 may flow through the ports 210 to produce required braking pressure.

A cut-off hole 710 in communication with the ports 210 may be formed in an outer surface of the sleeve 700.

A plurality of cut-off holes 710 may be arranged to be spaced apart from each other in a circumferential direction of the sleeve 700. Accordingly, the brake fluid inside the sleeve 700 may be discharged in a radial direction of the piston 600.

The sleeve 700 may be formed to be elongated in a longitudinal direction of the screw shaft 400. A front end of the sleeve 700 may be disposed adjacent to the bearing 900.

The bearing 900 may be located inside the block unit 1100, and may be provided at an end inside the main cylinder 200.

An outer surface of the bearing 900 and an outer surface of the sleeve 700 may be installed in contact with each other. The bearing 900 may be coupled to the screw shaft 400 in a shape enclosing the screw shaft 400.

The bearing 900 may be in contact with the sleeve 700, but a rotating portion of the bearing 900 may not contact the sleeve 700. When the rotating portion of the bearing 900 rotates, friction between the rotating portion of the bearing 900 and the sleeve 700 may be prevented from being caused. Accordingly, occurrence of impact noise during operation of the brake apparatus for vehicles may be suppressed, and shaft alignment compensation may be maintained, thereby reducing a noise, vibration and harshness (NVH) phenomenon.

The bearing 900 may include an inner ring 910, a bearing ball 915, and an outer ring 920.

The inner ring 910, as the rotating portion of the bearing 900, may be rotatably disposed inside the outer ring 920. The inner ring 910 may be in contact with the screw shaft 400 and may be disposed to be spaced apart from the sleeve 700.

The outer ring 920 may be disposed on an outer side of the inner ring 910 and may be in contact with the sleeve 700.

The screw shaft 400 and the bearing 900 may be coupled by press-fitting or the like. Accordingly, the screw shaft 400 and the bearing 900 may exhibit the same dynamic behavior. In the case where concentricity compensation is performed during operation of the piston 600, the screw shaft 400 may tilt, and accordingly the bearing 900 may also tilt. When the bearing 900 tilts, dynamic behavior in a radial direction may occur, and the bearing 900 may collide with the main cylinder 200 accordingly.

In an embodiment of the present disclosure, the bearing 900 may further include a vibration reducer 950 for impact attenuation and/or vibration reduction when the bearing 900 collides with the main cylinder 200.

The vibration reducer 950 may be disposed on an outer surface of the outer ring 920 that is at a side facing the main cylinder 200 and may be in contact with an inner wall of the main cylinder 200. The vibration reducer 950 may enclose the entirety or a portion of the outer surface of the outer ring 920.

The vibration reducer 950 may be formed including a rubber material. The vibration reducer 950 may be elastically deformed upon collision with the main cylinder 200, thereby further absorbing impact caused by the collision with the main cylinder 200.

A fitting groove 921 may be formed along a circumference of an outer circumferential surface of the outer ring 920. A fitting protrusion 951 may be formed along a circumference of an inner circumferential surface of the vibration reducer 950.

The bearing 900 may support an axial load during formation of hydraulic pressure inside the main cylinder 200 by the piston 600 reciprocating in the axial direction of the screw shaft 400.

The brake apparatus for vehicles according to an embodiment of the present disclosure may further include a reaction force component 750. The reaction force component 750 may have a first side supported by the main cylinder 200 and a second side in contact with the sleeve 700 and may press the sleeve 700 toward the bearing 900.

The brake apparatus for vehicles according to an embodiment of the present disclosure may further include a support component 1000. The screw shaft 400 may be secured to the bearing 900 by the support component 1000. The support component 1000 may rotatably support the screw shaft 400.

The support component 1000 may be provided inside the main cylinder 200. The support component 1000 may be threadedly coupled to the screw shaft 400. The bearing 900 may be secured to the support component 1000. The support component 1000 may support the screw shaft 400 so as to be rotatable on a central axis.

The support component 1000 may include a support bolt. A bolt head of the support bolt may be disposed in contact with the bearing 900. Thus, a gap between components may be controlled by adjusting a height of the bolt head, and space may be secured for reducing the size of the apparatus and a system or for modifying the design of adjacent components.

The backup master cylinder unit 100 according to an embodiment of the present disclosure may include a backup cylinder, a backup piston, a pedal simulator piston, a stopper, a first backup chamber, and a second backup chamber.

The backup piston may be disposed inside a body of the backup cylinder and may be movable in a forward and backward direction inside the body of the backup cylinder in response to pressing and releasing of the pedal 70. As the driver presses the pedal 70, the backup piston may move forward inside the body of the backup cylinder.

The pedal simulator piston may be movable in the forward and backward direction inside the body of the backup cylinder and may be disposed to be spaced apart from the backup piston. The pedal simulator piston may move forward in conjunction with the forward movement of the backup piston.

The block unit 1100 according to an embodiment of the present disclosure may include a hydraulic unit. The main master cylinder unit 30 and the backup master cylinder unit 100 may be mounted to the block unit 1100. A gasket 1400 may be coupled to the backup master cylinder unit 100.

The block unit 1100, as a single module mounted with the main master cylinder unit 30 and the backup master cylinder unit 100, may be mounted on a vehicle body. Various valves and flow paths may be formed inside the block unit 1100 to control the brake fluid passing through the main master cylinder unit 30 and the backup master cylinder unit 100.

The block unit 1100 may include a block body 1101. The block body 1101 may be formed in an approximately hexahedral shape. The block body 1101 may include a first surface 1102 and a second surface 1103 disposed opposite to the first surface 1102.

A main mounting bore 1110, to which the main master cylinder unit 30 is mounted, may be formed to pass through the first surface 1102 and the second surface 1103 across an interior of the block body 1101. The backup master cylinder unit 100 is mounted to a backup mounting bore 1130.

The main mounting bore 1110 may include a first block press-fitting portion 1111 disposed adjacent to the first surface 1102 of the block body 1101. An outer circumferential surface of the main cylinder 200 of the main master cylinder unit 30 may be press-fitted into the first block press-fitting portion 1111.

Alternatively, the main mounting bore 1110 may include a second block press-fitting portion 1112 disposed adjacent to the second surface 1103 of the block body 1101. The outer circumferential surface of the main cylinder 200 of the main master cylinder unit 30 may be press-fitted into the second block press-fitting portion 1112.

Alternatively, the main mounting bore 1110 may include both the first block press-fitting portion 1111 disposed adjacent to the first surface 1102 of the bock body 1101 and the second block press-fitting portion 1112 disposed adjacent to the second surface 1103 of the block body 1101. The outer circumferential surface of the main cylinder 200 of the main master cylinder unit 30 may be press-fitted into at least one of first block press-fitting portion 1111 or the second block press-fitting portion 1112. The outer circumferential surface of the main cylinder 200 of the main master cylinder unit 30 may be press-fitted only into the first block press-fitting portion 1111, only into the second block press-fitting portion 1112, or into both the first block press-fitting portion 1111 and the second block press-fitting portion 1112.

Because the main cylinder 200 is press-fitted into at least one of the first block press-fitting portion 1111 or the second block press-fitting portion 1112 at one end of the main mounting bore 1110 (including a peripheral portion of the one end) or at opposite ends of the main mounting bore 1110 (including peripheral portions of the opposite ends), the block body 1101 and the main cylinder 200 are additionally sealed together with a sealing element 1120 at the press-fitting region of the one end or the opposite ends of the main mounting bore 1110.

Accordingly, the brake apparatus for vehicles according to an embodiment of the present disclosure may have an enhanced sealing effect, because double sealing is achieved by the press-fitting region and the sealing element 1120. The sealing element 1120 may include a first sealing element 1121, a second sealing element 1122, and a third sealing element 1123.

The main cylinder 200 may include a first cylinder press-fitting portion 210. Alternatively, the main cylinder 200 may include a second cylinder press-fitting portion 220. Alternatively, the main cylinder 200 may include both the first cylinder press-fitting portion 210 and the second cylinder press-fitting portion 220.

The first cylinder press-fitting portion 210 may include first stepped portions 211, 212, and 213 that are press-fitted into the first block press-fitting portion 1111.

The first stepped portions 211, 212, and 213 may include first press-fitting portions 211 and 212, and a first positioning shoulder portion 213.

The first press-fitting portions 211 and 212 are regions that are press-fitted into the first block press-fitting portion 1111. The first press-fitting portions 211 and 212 and the first block press-fitting portion 1111 may be press-fitted in surface contact with each other.

The first positioning shoulder portion 213 may have a larger outer diameter than the first press-fitting portions 211 and 212 so as to be stepped with respect to the first press-fitting portions 211 and 212. The first positioning shoulder portion 213 may be press-fitted in surface contact with the first block press-fitting portion 1111.

The first block press-fitting portion 1111 may be formed in a shape corresponding to the first stepped portions 211, 212, and 213. Accordingly, when the first press-fitting portions 211 and 212 and the first positioning shoulder portion 213 are formed in a stepped shape, the first block press-fitting portion 1111 may also be formed in a stepped shape so as to be in surface contact with the first press-fitting portions 211 and 212 and the first positioning shoulder portion 213.

The first block press-fitting portion 1111 may include regions, denoted by reference numerals 1111a and 1111b, that are in surface contact with the first press-fitting portions 211 and 212, and a region, denoted by reference numeral 1111c, that is in surface contact with the first positioning shoulder portion 213.

As the first positioning shoulder portion 213 has a larger outer diameter than the first press-fitting portions 211 and 212, the first positioning shoulder portion 213 is caught by the first block press-fitting portion 1111 and thus prevented from further moving over the first block press-fitting portion 1111. Accordingly, at a region 1111b where the first positioning shoulder portion 213 is caught by the first block press-fitting portion 1111, the main cylinder 200 is prevented from moving inside the block body 1101. Thus, in a process of press-fitting the main cylinder 200 to the block body 1101, a relative position between the main cylinder 200 and the block body 1101 may be accurately specified.

The first press-fitting portions 211 and 212 may include a stepped region in an intermediate portion thereof (a stepped region between reference numeral 211 and reference numeral 212 in FIG. 7). Accordingly, a region denoted by reference numeral 212 of the first press-fitting portions 211 and 212 may be caught by a region denoted by reference numeral 1111a of the first block press-fitting portion 1111 and thus secured in position. The first press-fitting portions 211 and 212 may also be formed to have the same outer diameter without a stepped region in the intermediate portion.

The second cylinder press-fitting portion 220 may include second stepped portions 221, 222, and 223 that are press-fitted to the second block press-fitting portion 1112.

The second stepped portions 221, 222, and 223 may include second press-fitting portions 221 and 222, and a second positioning shoulder portion 223.

The second press-fitting portions 221 and 222 are regions that are press-fitted into the second block press-fitting portion 1112. The second press-fitting portions 221 and 222 and the second block press-fitting portion 1112 may be press-fitted in surface contact with each other.

The second positioning shoulder portion 223 may have a larger outer diameter than the second press-fitting portions 221 and 222 so as to be stepped with respect to the second press-fitting portions 221 and 222. The second positioning shoulder portion 223 may be press-fitted in surface contact with the second block press-fitting portion 1112.

The second block press-fitting portion 1112 may be formed in a shape corresponding to the second stepped portions 221, 222, and 223. Accordingly, when the second press-fitting portions 221 and 222 and the second positioning shoulder portion 223 are formed in a stepped shape, the second block press-fitting portion 1112 may also be formed in a stepped shape so as to be in surface contact with the second press-fitting portions 221 and 222 and the second positioning shoulder portion 223.

The second block press-fitting portion 1112 may include regions, denoted by reference numerals 1112a and 1112b, that are in surface contact with the second press-fitting portions 221 and 222, and a region, denoted by reference numeral 1112c, that is in surface contact with the second positioning shoulder portion 223.

As the second positioning shoulder portion 223 has a larger outer diameter than the second press-fitting portions 221 and 222, the second positioning shoulder portion 223 is caught by the second block press-fitting portion 1112 and thus prevented from further moving over the second block press-fitting portion 1112. Accordingly, at a region 1112b where the second positioning shoulder portion 223 is caught by the second block press-fitting portion 1112, the main cylinder 200 is prevented from moving inside the block body 1101. Thus, in a process of press-fitting the main cylinder 200 to the block body 1101, a relative position between the main cylinder 200 and the block body 1101 may be accurately specified.

The second press-fitting portions 221 and 222 may include a stepped region in an intermediate portion thereof (a stepped region between reference numeral 221 and reference numeral 222 in FIG. 7). Accordingly, a region denoted by reference numeral 222 of the second press-fitting portions 221 and 222 may be caught by a region denoted by reference numeral 1112a of the second block press-fitting portion 1112 and thus secured in position. The second press-fitting portions 221 and 222 may also be formed to have the same outer diameter without a stepped region in the intermediate portion.

The first surface 1102 of the block body 1101 is a surface on which the motor 300 is mounted. An angle formed between a central axis of the main mounting bore 1110 and the first surface 1102 of the block body 1101 may be a right angle. Accordingly, concentricity between the main master cylinder unit 30 and the motor 300 may be easily secured by mounting the main master cylinder unit 30 in the main mounting bore 1110 and mounting the motor 300 on the first surface 1102 of the block body 1101. As a result, cost and time required for manufacturing the brake apparatus for vehicles may be reduced.

A plurality of positioning protrusions 1180 may be provided on the first surface 1102 of the block body 1101. The plurality of positioning protrusions 1180 may be arranged on a concentric circle. A center of the concentric circle of the positioning protrusions 1180 coincides with a central axis of the main mounting bore 1110 and a center of the motor 300.

The motor 300 may be fitted onto the positioning protrusions 1180 and mounted on the first surface 1102. In an embodiment, the inner portion of the motor cover 341 of the cover assembly 340 and 341 of the motor 300 may be fitted in contact with an outer portion of the positioning protrusions 1180.

By fitting the motor 300 only onto the plurality of positioning protrusions 1180, the motor 300 may be accurately positioned on the first surface 1102 of the block body 1101, and further, concentricity between the main master cylinder unit 30 and the motor 300 may be reliably secured.

According to the present disclosure, concentricity between a main master cylinder unit and a motor may be secured.

According to the present disclosure, the motor may be accurately positioned on a block unit by a positioning protrusion.

According to the present disclosure, because an angle formed between a central axis of a main mounting bore and a motor-mounting surface of a block body is a right angle, concentricity between the main master cylinder unit and the motor may be easily secured by mounting the main master cylinder unit in the main mounting bore and mounting the motor on the motor-mounting surface of the block body.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A brake apparatus for vehicles, comprising:
a reservoir configured to store brake fluid;
a backup master cylinder unit connected to the reservoir and configured to generate hydraulic pressure of a brake fluid by pressing of a pedal;
a main master cylinder unit connected to the backup master cylinder unit and configured to generate hydraulic pressure of the brake fluid by driving a motor; and
a block unit on which the backup master cylinder unit is mounted, the block unit including a flow path through which the brake fluid flows, and an inner circumferential surface into which an outer circumferential surface of a main cylinder of the main master cylinder unit is press-fitted.

2. The brake apparatus of claim 1,
wherein the block unit includes a main mounting bore passing through a first surface and a second surface of the block unit, the main mounting bore including a first block press-fitting portion disposed adjacent to the first surface, and
wherein the outer circumferential surface of the main cylinder is press-fitted into the first block press-fitting portion.

3. The brake apparatus of claim 2, wherein the main cylinder comprises a first cylinder press-fitting portion including a first stepped portion press-fitted into the first block press-fitting portion.

4. The brake apparatus of claim 3, wherein the first stepped portion comprises:
a first press-fitting portion press-fitted into the first block press-fitting portion; and
a first positioning shoulder portion having an outer diameter larger than an outer diameter of the first press-fitting portion so as to be stepped with respect to the first press-fitting portion, the first positioning shoulder portion determining a position of the main cylinder inside the block unit.

5. The brake apparatus of claim 1,
wherein the block unit includes a main mounting bore passing through a first surface and a second surface of the block unit, the main mounting bore including a second block press-fitting portion disposed adjacent to the second surface, and
wherein the outer circumferential surface of the main cylinder is press-fitted into the second block press-fitting portion.

6. The brake apparatus of claim 5, wherein the main cylinder comprises a second cylinder press-fitting portion including a second stepped portion press-fitted into the second block press-fitting portion.

7. The brake apparatus of claim 6, wherein the second stepped portion comprises:
a second press-fitting portion press-fitted into the second block press-fitting portion; and
a second positioning shoulder portion having an outer diameter larger than an outer diameter of the second press-fitting portion so as to be stepped with respect to the second press-fitting portion, the second positioning shoulder portion determining a position of the main cylinder inside the block unit.

8. The brake apparatus of claim 2, wherein the motor is mounted on the first surface, and an angle formed between a central axis of the main mounting bore and the first surface is a right angle.

9. The brake apparatus of claim 2,
wherein a plurality of positioning protrusions are provided on the first surface, and
wherein the motor is fitted to the plurality of positioning protrusions and mounted to the first surface.
